(19) United States
(12) Patent Application Publication
(10) Pub. No.: US 2013/0159463 A1
(43) Pub. Date: Jun. 20, 2013

(54) METHOD AND SYSTEM FOR TARGETED TRANSMISSION OF CONTENT

(71) Applicant: Frisco Smartapps, LLC, Frisco, TX (US)

(72) Inventors: Richard Gary BENTLEY, Frisco, TX (US); Timothy Joseph Aranki, Frisco, TX (US)

(73) Assignee: Frisco Smartapps, LLC, Frisco, TX (US)

(21) Appl. No.: 13/722,832

(22) Filed: Dec. 20, 2012

Related U.S. Application Data
(60) Provisional application No. 61/577,946, filed on Dec. 20, 2011.

(51) Int. Cl. H04L 29/08

(52) U.S. Cl. CPC H04L 67/10
USPC 709/217

(57) ABSTRACT

Methods and systems for targeted transmission of content to recipients located within a geographic area, based on preferences expressed by the recipients of the messages, without using pre-segmented shapes or forms to define the geographic area. The targeted content is transmitted to recipients located within a geographic area and to recipients who enter into the geographic area during the lifetime of the transmission. The targeted content is transmitted once to each recipient.

### RELATED APPLICATIONS

The present application claims the benefit of U.S. Provisional Patent Application No. 61/577,946 titled METHOD AND SYSTEM FOR TARGETED TRANSMISSION OF CONTENT filed on Dec. 20, 2011, the entirety of which is expressly incorporated by reference herein.

### BACKGROUND

There are known in the methods and systems used by vendors to connect with and communicate messages, such as advertisements, to their customers. Known methods include, for example, traditional social media methods, such as Facebook and Twitter, and traditional advertising methods, such as Google and AdWords, among other methods. Internet communication methods such as e-mail, instant messaging and blogging, are likewise well known.

These known methods suffer from a common disadvantage, however, namely that messages transmitted using these methods are not geographically targeted based on a preference expressed by a user that receives the messages, and based on the user's geolocation. Most messages are thus instantly (i.e., based on availability of access to the Internet) available to anyone around the world, regardless of geographic location, or are made available to a limited list of recipients only, such as addressees on a mailing list, again regardless of the recipients' locations around the world. There are known methods that target advertisements to a specific geographic area, but these methods are not based upon preferences expressed by the users that receive the messages. Currently, local businesses, vendors and other potential distributors of content are able to communicate messages that are targeted to potential mobile users in their locality, but only based on a grid of pre-segmented geographic shapes or forms (e.g., squares, rectangles, circles or other pre-defined shapes), over which the shape of the desired locality may be superimposed. Thus, such messages cannot be distributed within a truly user-defined geographic shape. For example, if the user-defined geographic shape is smaller than the pre-defined geographic shape (e.g., if the pre-defined geographic shape is a city block, and the messages are to be made available to participants in a conference held on the premises of a hotel located on that block), the messages will be made available to anyone within the confines of the city block (and not solely to the participants in the conference). Similarly, if the user defined geographic shape is a triangle, for example, and the pre-segmented shape is a circle, it would not be possible to confine the messages to mobile users located within the shape of the triangle only, regardless of whether the area of the triangle fits within one circle or spans several circles. Thus, for example, if a local vendor desires to market a given product or service to potential customers within the limits of the city where the vendor is located, the currently available methods and systems would not permit the vendor to do so with any degree of precision. Further, there is no efficient way of distributing content (e.g., emergency or other information) that may only be relevant within a given geographic area to persons located within the geographic area or persons who enter into the geographic area within the lifetime of the message (e.g., for the duration of the emergency).

There is an unmet need in the art, therefore, for methods and systems that allow targeted transmission of content to recipients located within a geographic area, based on preferences expressed by the users that receive the messages. There is a further unmet need in the art for methods and systems that allow targeted transmission of content to recipients located within a geographic area, without using pre-segmented shapes or forms to define the geographic area. There is yet a further unmet need in the art for methods and systems that allow targeted transmission of content to recipients located within a geographic area or to recipients who enter into the geographic area during the lifetime of the transmission.

### SUMMARY

The following presents a simplified summary of one or more aspects of the present invention in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present invention solve the above-identified needs, as well as others, by providing methods and systems that allow targeted transmission of content to recipients located within a geographic area, based on preferences expressed by the users that receive the messages. Further, aspects of the present invention are directed to methods and systems that allow targeted transmission of content to recipients located within a geographic area, without using pre-segmented shapes or forms to define the geographic area. In addition, aspects of the present invention are directed to methods and systems that allow targeted transmission of content to recipients located within a geographic area and to recipients who enter into the geographic area during the lifetime of the transmission.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

FIGS. 1A and 1B present example methods for targeted transmission of content, in accordance with aspects of the present invention.

FIG. 2 presents an example system diagram of various hardware components and other features, for use in accordance with aspects of the present invention.

FIG. 3 is a block diagram of various example system components, for use in accordance with aspects of the present invention.

FIG. 4 presents a high level diagram of a publisher-subscriber messaging system in accordance with aspects of the present invention.

FIG. 5 presents another example implementation in accordance with aspects of the present invention.

FIG. 6 presents yet another example implementation in accordance with aspects of the present invention.

### DETAILED DESCRIPTION

Aspects of the present invention are directed to targeted transmission of content to users with Internet-enabled mobile devices, such a mobile telephones, tablets, personal computers (PCs) and personal digital assistants (PDAs), among other wireless devices. A user may download an application that enables targeted transmission of content to a user's mobile device, and/or an application that polls a message delivery system for new messages in the user's current geo-location. However, those of ordinary skill in the art will recognize that the application(s) may be pre-loaded on the mobile device, or otherwise be resident on the mobile device such that there is no need to download it. Alternatively, the user's mobile device may transmit the geolocation of the user to the message delivery system Once the application has been downloaded or is otherwise resident on the user's mobile device, the user may indicate the user's preferences. For example, the user may indicate an interest in the category restaurants and subcategory Asian restaurants. In accordance with aspects of the present invention, there may be a variety of categories (e.g., grocery stores, dry cleaners, theaters) and subcategories for the user to select from. Additional example implementations of aspects of the present invention include, but are not limited to, college campuses, conference premises (e.g., hotel or convention center), or any other premises where messages (e.g., emergency or other messages) need to be sent out to mobile users within the confines of the premises (e.g., one or more city blocks or segments of a city).

Based on the user's location (e.g., geolocation comprised of latitude and longitude, for example) and the time of day (e.g., around lunchtime or dinnertime), the user may receive transmitted targeted content for a number of Asian restaurants located in the vicinity (e.g., within 5 miles of the user's location). The user's location may be determined based on information provided by the mobile device, such as mobile network information, Global Positioning System (GPS) coordinates, or may be input by the user or otherwise determined. The targeted content may include information regarding the location of the restaurant, information on the menu and specials and/or discount offers, for example. In accordance with some aspects of the invention, each vendor may specify the radius (or other geographic area having any geoshape that is desirable) and/or the time period during which the targeted content is to be transmitted. The geographic area specified by the vendor is interchangeably referred to herein as a geodetic threshold.

In accordance with one aspect, a user may have a mobile application installed or otherwise resident on the mobile device that polls the message delivery system for new messages in the user's current geo-location. Alternatively, the user's mobile device may transmit the geolocation of the user to the message delivery system, which may determine whether any content exists that matches the user's stated preferences and/or whether the user is within the geographic area specified by the vendor, for example. If there is content available for transmission that matches the user's preferences, and if the user's geolocation is within the geographic area specified by the vendor, the content is then transmitted to the user. It will be recognized by those of ordinary skill in the art that the user's mobile device may be polled for geolocation coordinates at variable predetermined intervals or randomly. Similarly, the server application may make the determination as to whether or not to send content to the user's mobile device at variable predetermined intervals or randomly.

In accordance with some aspects, the user may be notified or alerted via the user's mobile device (e.g., via buzzing, audio or other notification) that targeted content is available. The user may then access the targeted content. In accordance with some aspects, the alert may be different for each of the categories the user has indicated an interest in (e.g., buzzing for restaurants, specific tune for dry cleaners, etc.).

The targeted content may be transmitted to all users that enter, e.g., the geodetic threshold, within a pre-defined period of time. Thus, the targeted content may be initially transmitted to 50 users within the specified geographic area, for example, and then to another 20 users who enter the specified geographic area at a later time, but before the lifetime of the targeted content has expired. Conversely, the users who received the targeted content initially but subsequently exited the specified geographic area, may no longer have access to the targeted content, in accordance with some aspects of the present invention. In accordance with one aspect, targeted content may be sent (interchangeably referred to herein as “pushed”) to the user's mobile device based on the user's last recorded geolocation. That is, if a user's geolocation is not updated (which may occur for a variety of reasons, e.g., the user's mobile device may be shut down, service may not be available, etc.) and targeted content corresponding to the user's preferences is available, it may be pushed to the user if the last recorded geolocation of the user is within the specified geographic area, even if the user has exited the geographic area.

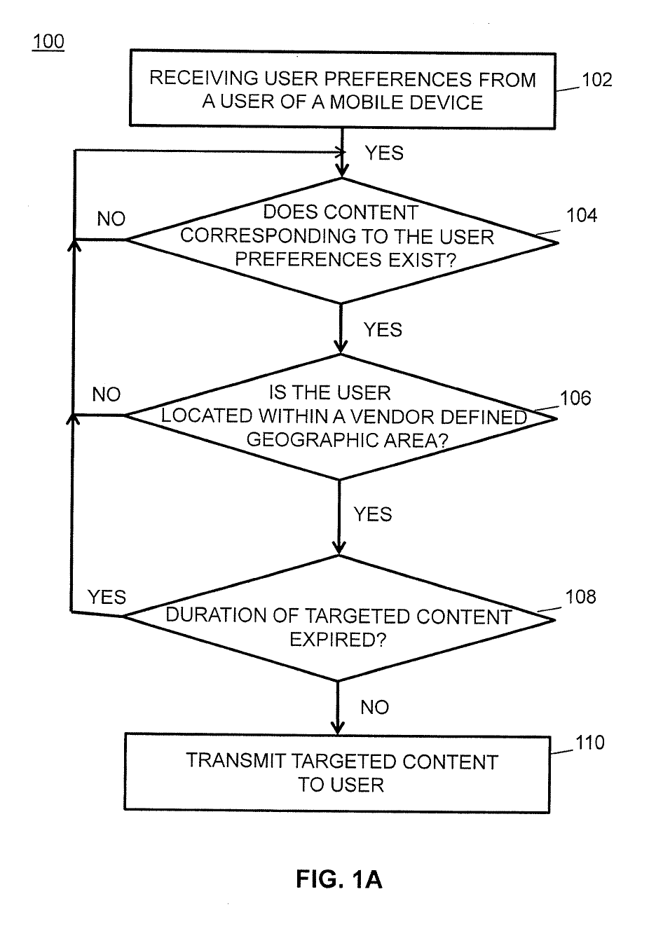

Referring now to FIG. 1A, therein shown is example method 100 for targeted transmission of content, in accordance with aspects of the present invention. The preferences of a user of a mobile device may be received 102. A determination is made as to whether content corresponding to the user's preferences exists 104. If such content exists, a determination is made as to whether the user is located within a pre-specified geographic area 106. If such content does not exist, no transmission is made to the user. If the user is located within the specific geographic area, a determination is made as to whether the duration of the content has expired. If the user is not located within the pre-specified geographic area, no transmission is made to the user. If the duration has not expired, the content is transmitted to the user. Otherwise, the content is not transmitted. It will be recognized that the above order of determinations is just an example, and that the determination of whether the duration of the content has expired may be made prior to making the determination as to whether the user is within the pre-specified geographic area, for example.

Referring now to FIG. 1B, therein shown is another example method 150 for targeted transmission of content, in accordance with aspects of the present invention. Once applications enabling targeted transmission of content are downloaded, pre-loaded or is otherwise resident on users' mobile devices 152, the users may indicate their preferences 154. Alternatively, the users' mobile devices may transmit the geolocation of the users to a message delivery system, which may determine whether any content exists that matches the user's preferences received at 154. Upon making a first determination that targeted content corresponding to the users' preferences, that the duration of the targeted content has not expired, and that the users are located within the pre-specified geographic area, the targeted content may be transmitted to the mobile devices 156 of a first group of users. Upon making a second determination that the duration of the targeted content has not expired 158, the targeted content is transmitted to a second group of users who entered the pre-specified geographic area after the first determination was made, and whose preferences also correspond to the targeted content 160. Upon determining that the duration of the targeted content has expired, the transmission of the targeted content ends 162.

As another example, aspects of the present invention may be implemented in the location of a conference or other event (e.g., within the area of a convention center, hotel, etc.). In this example implementation, the host (e.g., conference organizer) may communicate targeted content to all participants in the conference while they are located on the premises of the convention center/hotel. In addition, however, according to aspects of the present invention, the participants may be able to send additional targeted content, similar to Twitter to the host and/or all other participants or a subset thereof that are located on the premises. In this scenario, the host may also be a user and vice versa. This would allow a group of individuals or entities that are participants in an event to communicate among each other on the premises of the event, while excluding individuals who are participants in the event, but are not present on the premises of the event. In accordance with one aspect, the targeted content may be transmitted in accordance with geo-coordinates and within a specific altitude, thereby defining a three-dimensional area for the transmission of the targeted content. In addition the three-dimensional area may span a range of altitudes, and may cover a specific floor or range of floors of a building, such as a convention center, for example.

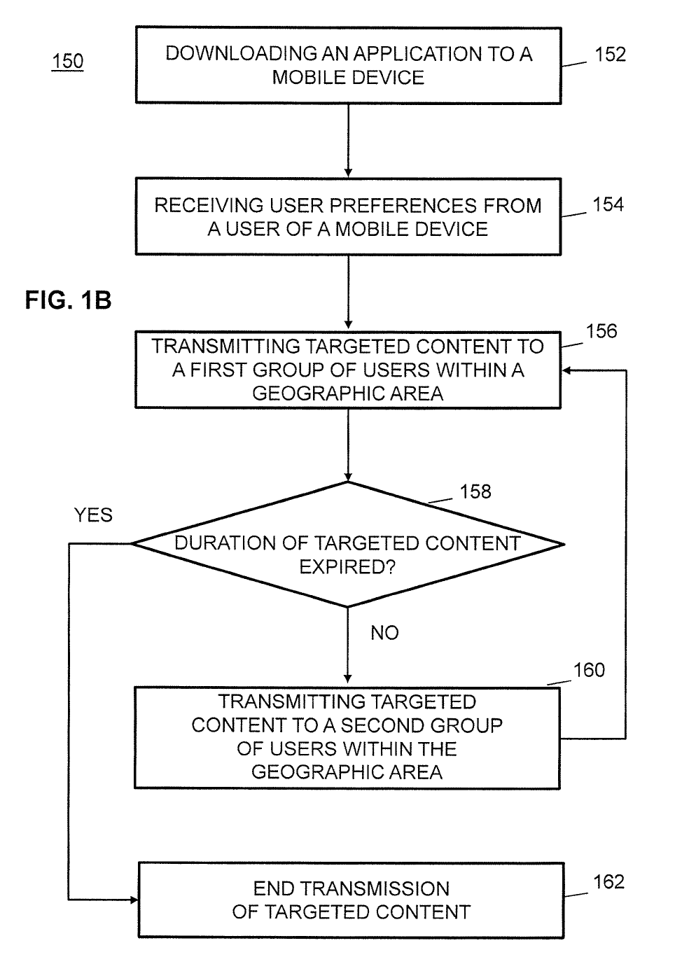

In some variations, aspects of the present invention may be directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software aspects are described in terms of this example computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative aspects, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 210 to perform the features of the present invention. Accordingly, such computer programs represent controllers of the computer system 200.

In an aspect where the invention is implemented using software, the software may be stored in a computer program product and loaded into computer system 200 using removable storage drive 214, hard drive 212, or communications interface 220. The control logic (software), when executed by the processor 204, causes the processor 204 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

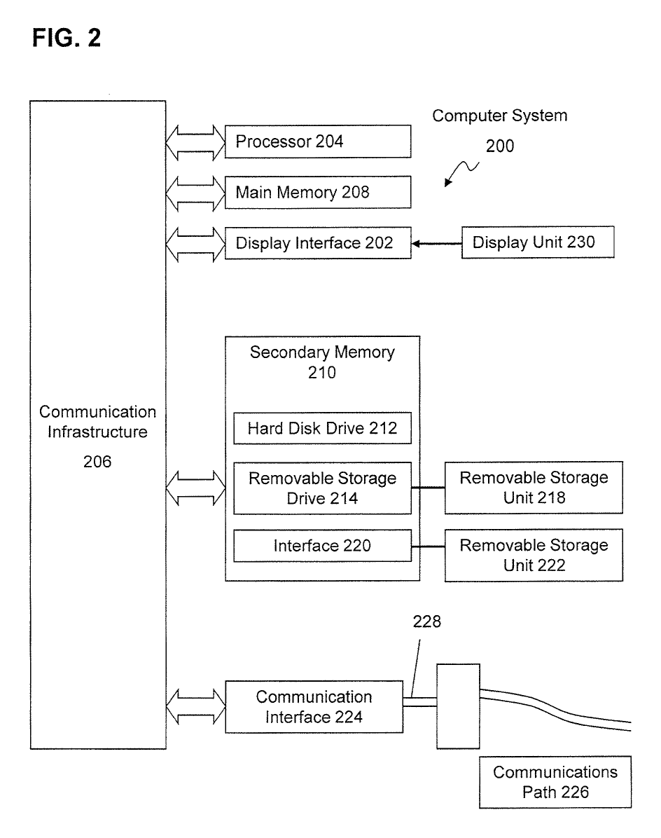

FIG. 3 shows a communication system 300 involving use of various features in accordance with aspects of the present invention. The communication system 300 includes one or more assessors 360, 362 (also referred to interchangeably herein as one or more “users”) and one or more terminals 342, 366 accessible by the one or more accessors 360, 362. In one aspect, operations in accordance with aspects of the present invention is, for example, input and/or accessed by an accessor 360 via terminal 342, such as personal computers (PCs), minicomputers, mainframe computers, microcomputers, telephonic devices, or wireless devices, such as personal digital assistants (“PDAs”) or a hand-held wireless devices coupled to a remote device 343, such as a server, PC, minicomputer, mainframe computer, microcomputer, or other device having a processor and a repository for data and/or connection to a repository for data, via, for example, a network 344, such as the Internet or an intranet, and couplings 345, 364. The couplings 345, 364 include, for example, wired, wireless, or fiberoptic links. In another aspect, the method and system of the present invention operate in a stand-alone environment, such as on a single terminal.

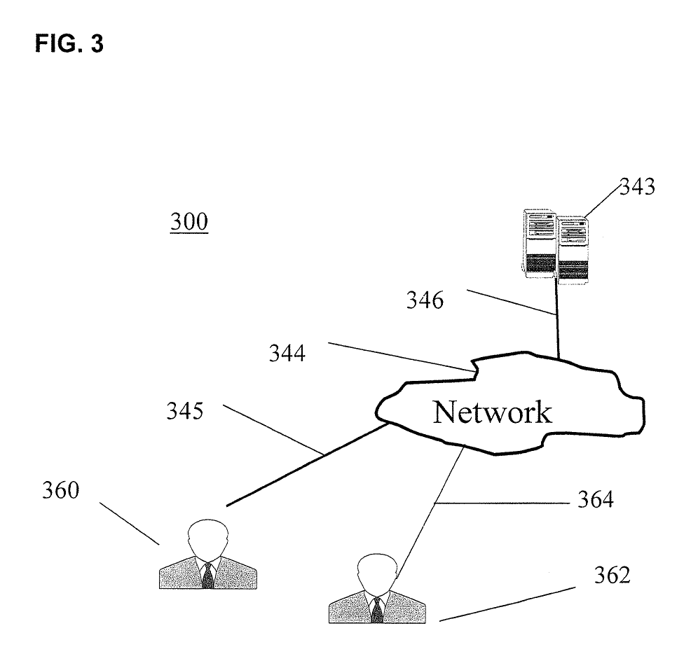

Referring now to FIG. 4, therein shown is a high level diagram 400 of a publisher-subscriber messaging system in accordance with aspects of the present invention. The environment may include a message publication, management and delivery system 406. Publishers 402 may directly, or indirectly, enter, maintain, and track message information in the system. Messages can be in any encoded form as specified by the publisher, but can include plain text, markup (such as HTML or XML), or be multi-part messages with embedded media, etc. Publishers 402 may submit messages to be published along with geo-location data for the targeted area in which the message will be delivered to subscribers of the system 404. Subscribers 410 can request messages 408 that are published to their current geo-location. Subscribers 410 may provide a unique ID to the system when requesting messages to ensure single instance delivery of messages as well as tracking information for the publisher 402 of delivered messages.

A publisher 402 may be, for example, a business wishing to publish a message to nearby potential customers to notify them of activities, offers or other transactions at their place of business. The business may only want to publish the message to potential customers (interchangeably referred to herein as subscribers) 410 within a ¼ mile radius, for example, of their location, or other appropriate geographic area, as the activities may be, e.g., time-sensitive.

A subscriber 410 may be, for example, any user having a mobile application installed that polls the message delivery system for new messages in the user's current geo-location. The poll to the server may include a unique ID to indicate the user or application install instance and the current geo-location of the mobile device. The response may include messages published in the area that the user may receive notification of.

Another example of a subscriber 410 may be a content server that receives requests for content in a current location and augments traditional content with published messages for the specified geo-location. This information could then be augmented or expanded to include further details relevant details about the publisher, for example address or route information.

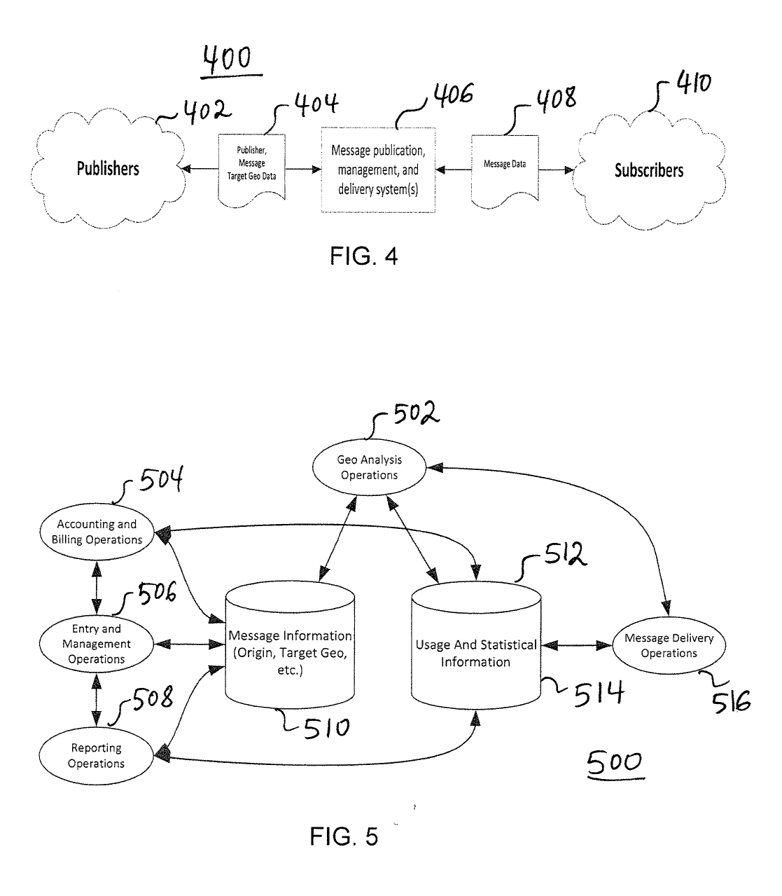

Referring now to FIG. 5, therein shown is an example message publishing system 500 in accordance with aspects of the present invention. The example message publishing system may include a message information system, including data regarding a message's origin and target geographic area 510, and may store message information and usage or historical/statistical information 512. The example system may support the creation and management of published and non-published messages through entry and management operations 506, reporting operations 508, accounting and billing operations 504, message delivery operations 516, and geo analysis operations 502. Publishers may interface with the system via the entry and management operations 506, while subscribers may interface with the system via the message delivery operations 516.

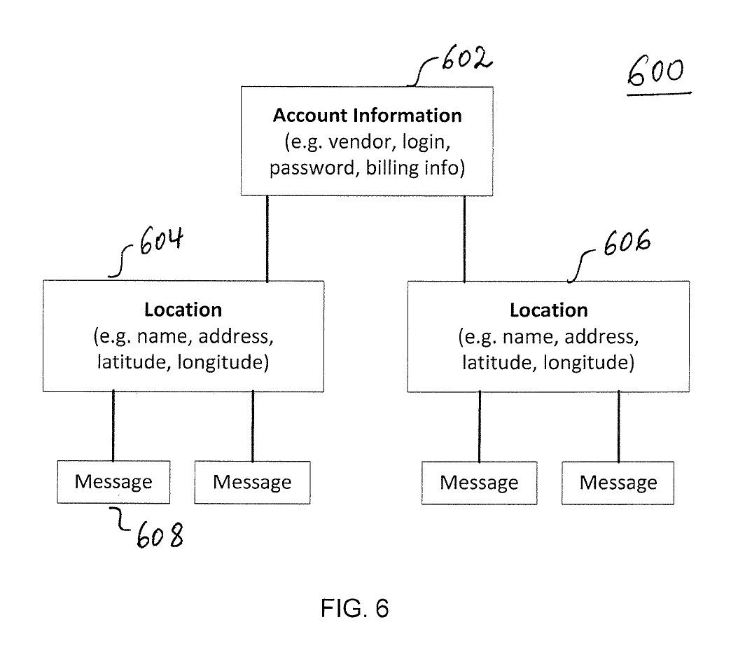

In one aspect of the example message publishing system, a social application for publishing messages between business and customers may include information about vendor accounts, locations, messages, etc. FIG. 6 illustrates an example inter-relationship of publisher information 600, in accordance with aspects of the present invention. Account information 602 may include user login, password, and business or vendor billing information, among other information. Account information 602 may be associated to one or more locations 604, 606, which may include the name of the location, address information, and geo-coordinates, among other information. A location 604, 606 may then have messages 608 associated to it, where messages 608 may include geographical data for targeting, begin and end date and or time to indicate message lifetime, and the value of the message. For example, a restaurant chain may have multiple locations defined with separate messages broadcast to subscribers based on the location to increase relevance of message content (e.g. band that is playing, local specials, grand opening).

Referring again to FIG. 5, the messages may be created and managed via the entry and management operations 506. Each message may be created such that it has a lifetime associated with it (e.g. start, end, duration) and geographical data (e.g., geo-coordinate+radius, shaped region defined by geo-coordinates, proximity to current geo-coordinate, etc.). The geo analysis operations 502 may evaluate subscriber requests based on the subscriber geo-coordinates to determine existing messages that are within range but have not previously been sent. The geo analysis operations 502 may also record message deliveries as well as subscriber geo-coordinates for message delivery and proximity reporting. The reporting operations 508 may be employed to evaluate subscriber delivery by geographical area and may be displayed over time. The capture of subscriber geo-coordinates allows for reporting of subscriber location in relation to the published location for the message, allowing for publishers to evaluate the effect of message content and optimize delivery times and geo targets.

In accordance with one aspect, a user may have a mobile application installed or otherwise resident on the mobile device that polls the message delivery system for new messages in the user's current geo-location. Alternatively, the user's mobile device may transmit the geolocation of the user to the message delivery system, which may determine whether any content exists that matches the user's stated preferences and/or whether the user is within the geographic area specified by the vendor, for example. If there is content available for transmission that matches the user's preferences, and if the user's geolocation is within the geographic area specified by the vendor, the content is then transmitted to the user. While aspects of the present invention has been described in conjunction with the example implementations outlined above, various alternatives, modifications, variations, improvements, and/or substantial equivalents, whether known or that are or may be presently unforeseen, may become apparent to those having at least ordinary skill in the art. Accordingly, the example aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

1. A computer-assisted method for targeted transmission of content, the computer comprising a processor, the method comprising:
receiving a user preference from a user of a mobile device;
receiving a geolocation of the user; and
transmitting, via the processor, content corresponding to the user preference, the content having a predetermined lifetime, to the mobile device, if the user is located, based on the geolocation of the user, within a geodetic threshold during the lifetime of the content.

2. The method of claim 1, further comprising:
alerting the user of the transmitted content.

3. The method of claim 1, wherein the transmitting is recorded in a memory of the computer.

4. The method of claim 1, wherein the content is transmitted to the user if it was not previously transmitted to the user.

5. The method of claim 1, further comprising:
evaluating an effect of the transmitted content on the user; and
optimizing a delivery time and the predefined geographic area based on the evaluating.

6. The method of claim 1, wherein the geodetic threshold is a two-dimensional area.

7. The method of claim 1, wherein the geodetic threshold is a three-dimensional area.

8. A computer-assisted method for targeted transmission of content, the computer comprising a processor, the method comprising:
receiving a user preference from a user of a mobile device;
receiving a geolocation of the user;
determining, via the processor, whether content corresponding to the user preference exists and has not expired;
if content corresponding to the user preference exists and has not expired, determining whether the user is located within a geodetic threshold based on the geolocation of the user; and
if the user is located within the geodetic threshold, transmitting the content to the user.

9. The method of claim 8, further comprising:
alerting the user of the transmitted content.

10. The method of claim 8, wherein the content is transmitted to the user if it was not previously transmitted to the user.

11. The method of claim 8, further comprising:
evaluating an effect of the transmitted content on the user; and
optimizing a delivery time and the predefined geographic area based on the evaluating.

12. A system for targeted transmission of content comprising:
a publisher; and
a message publication, management and delivery module (MPMDM), wherein:
a user preference is received from a user of a mobile device at the MPMDM;
a geolocation of the user is received at the MPMDM; and
a content provided by the publisher, having a predetermined lifetime, is transmitted by the MPMDM to the mobile device if it corresponds to the user preference and if the user is located, based on the geolocation of the user, within a predefined geographic area during the lifetime of the transmitted content.

13. A system for targeted transmission of content comprising:
a module for receiving a user preference from a user of a mobile device;
a module for receiving a geolocation of the user;
a module for determining whether content corresponding to the user preference exists and has not expired;
a module for determining whether the user is located within a geodetic threshold based on the geolocation of the user, the determination being made if content corresponding to the user preference exists and has not expired; and
a module for transmitting the content to the user if the user is located within the geodetic threshold.

14. A system for targeted transmission of content comprising:
a processor;
a user interface functioning via the processor; and
a repository accessible by the processor; wherein
a user preference from a user of a mobile device is received;
a geolocation of the user is received;
a determination is made, via the processor, whether content corresponding to the user preference exists and has not expired;
if content corresponding to the user preference exists and has not expired, a determination is made whether the user is located within a geodetic threshold based on the geolocation of the user; and
if the user is located within the geodetic threshold, the content is transmitted to the user.

15. The system of claim 14, further comprising:
a module for alerting the user of the transmitted content.

16. The system of claim 14, wherein the content is transmitted to the user if it was not previously transmitted to the user.

17. A system for targeted transmission of content comprising:
a processor;
a user interface functioning via the processor; and
a repository accessible by the processor; wherein
a user preference from a user of a mobile device is received;
a geolocation of the user is received; and
content having a predetermined lifetime and corresponding the user preference is transmitted to the mobile device via the processor, if the user is located, based on the user's geolocation, within a geodetic threshold during the lifetime of the content.

18. The system of claim 17, wherein the content is transmitted to the user if it was not previously transmitted to the user.

19. A computer program product comprising a computer usable medium having control logic stored therein for causing a computer to perform targeted transmission of content, the control logic comprising:
computer readable program code means for receiving a user preference from a user of a mobile device;
computer readable program code means for receiving a geolocation of the user; and
computer readable program code means for transmitting, via the processor, content corresponding to the user preference, the content having a predetermined lifetime, to the mobile device, if the user is located, based on the geolocation of the user, within a geodetic threshold during the lifetime of the content.

20. A computer program product comprising a computer usable medium having control logic stored therein for causing a computer to perform targeted transmission of content, the control logic comprising: computer readable program code means for receiving a user preference from a user of a mobile device;
computer readable program code means for receiving a geolocation of the user;
computer readable program code means for determining, via the processor, whether content corresponding to the user preference exists and has not expired;
computer readable program code means for determining whether the user is located within a geodetic threshold based on the geolocation of the user, if content corresponding to the user preference exists and has not expired; and
computer readable program code means for transmitting the content to the user if the user is located within the geodetic threshold.
